(19) United States
(12) Patent Application Publication
(10) Pub. No.: US 2021/0053483 A1
(43) Pub. Date: Feb. 25, 2021

(54) INFORMATION DISPLAY DEVICE AND INFORMATION DISPLAY METHOD

(71) Applicant: MITSUBISHI ELECTRIC CORPORATION, Tokyo (JP)

(72) Inventors: Masaaki TAKEYASU, Tokyo (JP); Munetaka NISHIHIRA, Tokyo (JP); Shinsaku FUKUTAKA, Tokyo (JP); Akiko IMAISHI, Tokyo (JP)

(73) Assignee: MITSUBISHI ELECTRIC CORPORATION, Tokyo (JP)

(21) Appl. No.: 17/094,100

(22) Filed: Nov. 10, 2020

Related U.S. Application Data
(63) Continuation of application No. PCT/JP2018/025355, filed on Jul. 4, 2018.

(51) Int. Cl. B60Q 1/08; B60K 35/00; G06K 9/00; G06T 7/70

(52) U.S. Cl. CPC B60Q 1/085; B60K 35/00; G06K 9/00362; G06T 7/70; B60Q 2400/50; B60Q 2300/312; B60K 2370/152; B60Q 2300/45; B60K 2370/349; B60Q 2300/324; B60K 2370/334; B60K 2370/162

(57) ABSTRACT

The information display device (100) includes a person detection unit (40) that detects a position and a direction of a person, and a display data acquisition unit (50) that acquires display data for displaying information. The information display device (100) includes a decision unit (69) that identifies based on the position and the direction of the person detected by the person detection unit (40), visibility of the display information displayed by the display data selected by a display data selection unit (52), and decides a projection mode of light based on the visibility. Further, the information display device (100) includes an information display unit (70) that displays the information based on the projection mode of light decided by the decision unit (69). The decision unit (69) includes a display data correction unit (60) that corrects the display data and outputs corrected data.

### CROSS REFERENCE TO RELATED APPLICATIONS

This application is a Continuation of PCT International Application No. PCT/JP2018/025355 filed on Jul. 4, 2018, which is hereby expressly incorporated by reference into the present application.

### TECHNICAL FIELD

The present invention relates to an information display device and an information display method for displaying information.

Specifically, the present invention relates to an information display device and an information display method for displaying information outside a moving vehicle.

### BACKGROUND ART

In recent years, an information display device is known (for example, Patent Literature 1) which displays information outside a vehicle by projecting a light beam onto a road by a projection device mounted on the vehicle.

In the information display device disclosed in Patent Literature 1, a predetermined pattern is projected onto a road surface when a vehicle speed is 0 or less than a predetermined speed, and the projection of the predetermined pattern is stopped when the vehicle speed exceeds the predetermined speed. Further, this device includes a detection unit for detecting an environment state around the vehicle, and when the environment state around the vehicle is worse than a determination threshold value set in advance, visibility improvement control to improve a visibility of the predetermined pattern is performed. As the visibility improvement control, for example, a method for changing a luminance degree or a hue of a light source of the light beam is presented.

### CITATION LIST

### Patent Literature

Patent Literature 1: JP2016-101797A

### SUMMARY OF INVENTION

### Technical Problem

In Patent Literature 1, when it is determined that the environment state around the vehicle is bad, it is possible to improve the visibility of the display pattern by changing the luminance degree or the hue of the predetermined pattern.

When a specific intention is indicated to a person outside the vehicle by using a display pattern such as an arrow, the visibility of the display pattern to the targeted person expected to be conveyed the intention is important. If the display pattern to be irradiated has a poor visibility to the targeted person expected to be conveyed the intention, the intention is not conveyed to the expected person, and the display becomes meaningless.

The present invention aims to provide an information display device and an information display method for providing a display easy for a person in the vicinity of a vehicle to view.

### Solution to Problem

An information display device according to the present invention includes:

a person detection unit to detect a position of a person;

a display data acquisition unit to acquire display data for displaying information;

a decision unit to identify based on the position of the person detected by the person detection unit, visibility of display information displayed by the display data acquired by the display data acquisition unit, and decide a projection mode of light based on the visibility; and

an information display unit to display the display information onto a projection surface based on the projection mode of light decided by the decision unit.

### Advantageous Effects of Invention

According to the present invention, it is possible to enhance a visibility of display information since a projection mode of light is decided by determining the visibility of the display information as viewed from a position of a person.

### BRIEF DESCRIPTION OF DRAWINGS

FIG. 1 is a system configuration diagram of an information display device 100 according to a first embodiment;

FIG. 2 is an example illustrating a hardware configuration of the information display device 100 according to the first embodiment;

FIG. 3 is a flowchart illustrating an operation procedure of the information display device 100 according to the first embodiment;

FIG. 4 is an example illustrating correction data 64 of display data according to the first embodiment;

FIG. 5 is an example illustrating an irradiation state of display information 75 onto a road surface according to the first embodiment;

FIG. 6 is an example illustrating a method for irradiating the display information 75 onto the road surface according to the first embodiment;

FIG. 7 is an example illustrating a method for changing a lighting area of the display information 75 onto the road surface according to the first embodiment;

FIG. 8 is an example illustrating the method for irradiating the display information 75 onto the road surface according to the first embodiment;

FIG. 9 is an example illustrating the method for irradiating the display information 75 onto the road surface according to the first embodiment;

FIG. 10 is an example illustrating the method for irradiating the display information 75 onto the road surface according to the first embodiment;

FIG. 11 is an example illustrating a method for changing a hue of the display information 75 onto the road surface according to the first embodiment;

FIG. 12 is a system configuration diagram of an information display device 100 according to a second embodiment; and

FIG. 13 is an example illustrating correction data 64 of display data according to the second embodiment.

### DESCRIPTION OF EMBODIMENTS

### First Embodiment

***Description of Configuration***

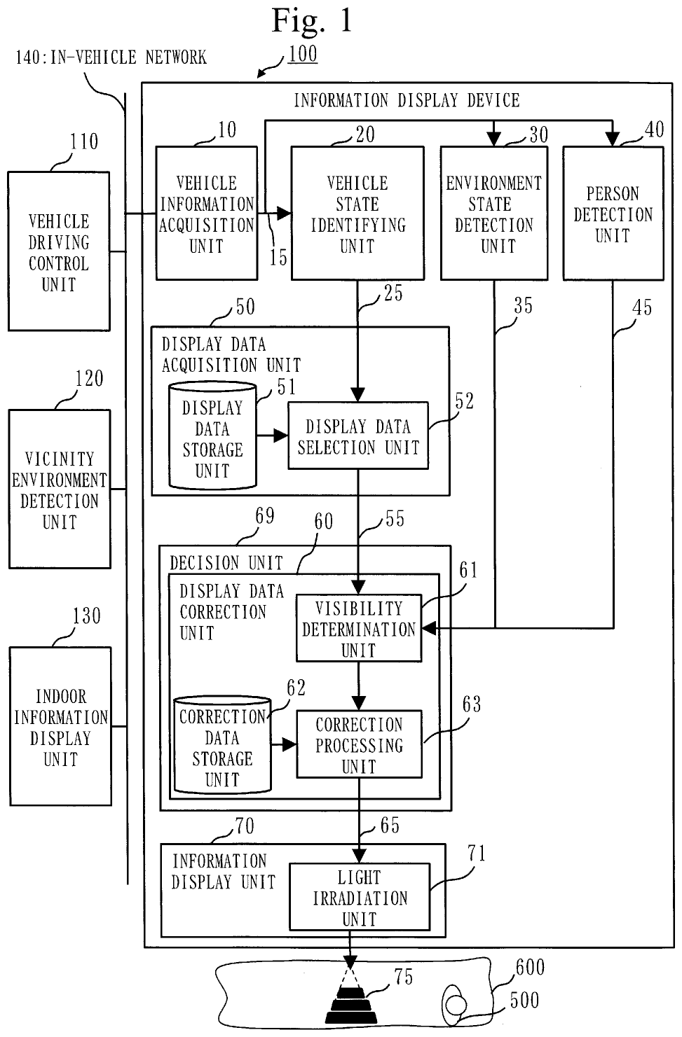

FIG. 1 is a configuration diagram of an information display device 100 according to a first embodiment.

The information display device 100 acquires vehicle information 15 indicating a vehicle state via an in-vehicle network 140 from an on-vehicle apparatus such as a vehicle driving control unit 110, a vicinity environment detection unit 120, or an indoor information display unit 130.

The information display device 100 is a device that identifies the vehicle state based on the vehicle information 15 and outputs display information 75 onto a display surface outside the vehicle based on display data 55 corresponding to the identified vehicle state.

The vehicle driving control unit 110 is a processing unit that controls driving of the vehicle such as engine control, brake control, and steering control.

The vicinity environment detection unit 120 is a processing unit that acquires information on the vicinity environment of the vehicle by using a vehicle front camera, a vehicle rear camera, a LIDAR (Light Detection and Ranging, Laser Imaging Detection and Ranging), a sonar, a V2X (Vehicle-to-Vehicle, Vehicle-to-Infrastructure) on-vehicle apparatus, an illuminance sensor, a rain sensor, a locator, and the like.

The indoor information display unit 130 is a processing unit, such as a car navigation device, which presents information to a passenger such as an indoor driver.

A configuration of the information display device 100 will be described.

A vehicle information acquisition unit 10 includes an interface apparatus for the in-vehicle network 140, such as, for example, a CAN (Controller Area Network) or Ethernet (registered trademark).

The vehicle information acquisition unit 10 performs a process of acquiring the vehicle information 15 indicating the vehicle state, via the in-vehicle network 140 from an on-vehicle apparatus. The vehicle information 15 includes: for example, operation information such as winkers, an accelerator, brakes, and a shift lever; vehicle state information such as a vehicle speed and a steering wheel driving angle; obstacle information and pedestrian information which are detected by a vehicle front camera or the like; location information acquired by a locator; map information which is output from a car navigation device; and the like.

A vehicle state identifying unit 20 identifies the vehicle state based on the vehicle information 15 acquired by the vehicle information acquisition unit 10 and outputs state information 25. The state information 25 includes: for example, information indicating behavior of the vehicle such as a backward movement or a forward movement; vehicle state information such as a vehicle speed; or obstacle information such as a position of an object in the vicinity of the vehicle. For example, the backward movement of the vehicle can be determined based on the operation information of the shift lever and the vehicle speed which are notified with the vehicle information 15.

A display data acquisition unit 50 includes a display data storage unit 51 and a display data selection unit 52.

The display data acquisition unit 50 acquires the display data 55 for displaying the information indicating the vehicle state identified by the vehicle state identifying unit 20, and outputs the display data 55.

The display data 55 is data for forming the display information 75, and has following data.

1. shape data of a lighting area,

2. movement direction data of the lighting area,

3. lighting time and lights-out time data,

4. luminance degree data of the lighting area,

5. hue data of the lighting area,

6. sound data or voice data, and

7. other attribute data.

The display data storage unit 51 stores for each of the vehicle states, the display data 55 for displaying information presented to the outside of the vehicle. The display data 55 stored in the display data storage unit 51 is, for example, animation display data including the information to be presented to the outside of the vehicle.

The display data selection unit 52 performs a process of selecting the display data 55 corresponding to the vehicle state identified by the vehicle state identifying unit 20, from a plurality of pieces of display data stored in the display data storage unit 51.

An environment state detection unit 30 is a processing unit that detects an environment state outside the vehicle.

The environment state detection unit 30 identifies a state of a projection surface onto which the display data 55 is projected, and a weather state when the display data 55 is projected, and outputs the states as environment information 35.

The state of the projection surface is an unevenness state of the road surface, a presence/absence state of a puddle, or a road surface state such as being dry, wet, submerged, snow-covered, or frozen.

The weather state is information regarding weather such as rain, snow, or fog, and information indicating an atmospheric state such as rainfall or fog density.

Besides, since a process of identifying the unevenness state of the road surface, the presence/absence state of a puddle, and the road surface state based on the camera information is a known technique, the descriptions thereof are omitted. Also, the road surface state such as being dry or wet can be acquired from road traffic information, or can also be acquired by a road surface sensor using near infrared rays or the like.

A person detection unit 40 detects a person 500 in the vicinity of the vehicle and outputs the person 500 as person detection information 45. Here, the person 500 is a pedestrian, a passenger of a bicycle or an automobile, or the like. The person detection unit 40 detects based on the video information of the camera, a face position and direction of the person or a position and direction of the passenger's face of the bicycle or the automobile.

A face position can be generally indicated by three-dimensional coordinates using a geographic coordinate system. However, here, a face position refers to a relative position with respect to a display position in the display information 75. Hereinafter, it is assumed that there are three types of positional relationships of a front, a side, and a back as the face position. The positional relationship refers to a relative positional relationship between the position of the person 500 and the display position of the display information 75.

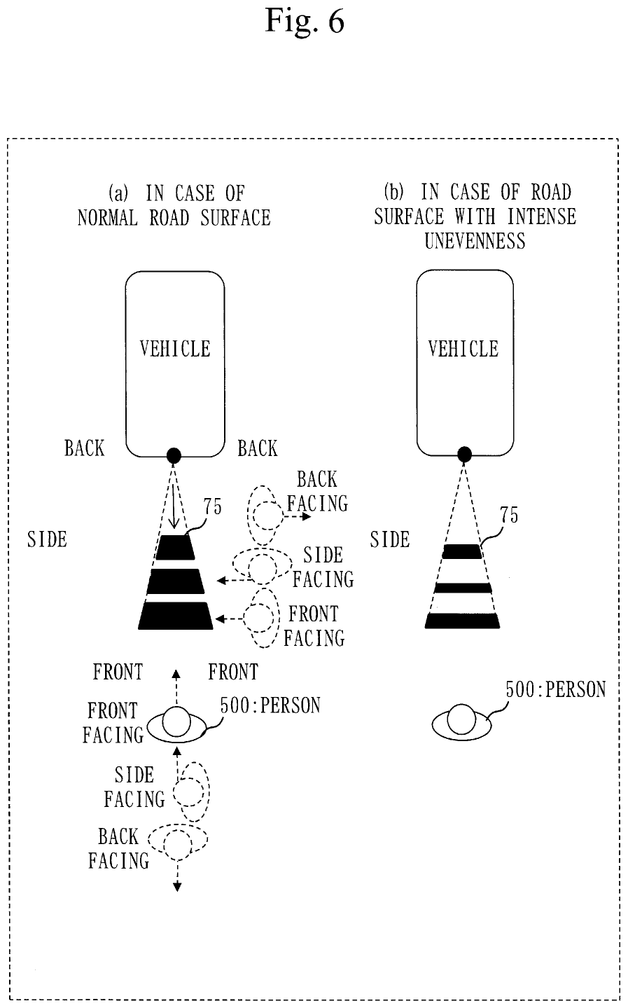

As illustrated in FIG. 6, the front refers to a case in which the person 500 is positioned farther from the vehicle than the display position of the display information 75 in a projection direction indicated by an arrow. The side refers to a case in which the person 500 is on a flank of a projection irradiation area and is on the side of the display position of the display information 75. The back refers to a case in which the person 500 is positioned closer to a vehicle side than the display position of the display information 75 in the projection direction.

Hereinafter, the face position of the person 500 is also merely referred to as a position of the person 500.

The face direction can be generally indicated by a direction using north, south, east, and west. Here, the face direction refers to a face direction with respect to the display position of the display information 75. Hereinafter, it is assumed that there are three types of directions of front facing, side facing, and back facing as the face directions.

As illustrated in FIG. 6, the front facing refers to a case in which the display information 75 is viewed from the front. The side facing refers to a case in which the display information 75 is obliquely viewed with a sideways glance. The back facing refers to a case in which the display information 75 is faced by the person's back. In the following description of the first embodiment, a case in which the face direction is the front facing is mainly described.

Hereinafter, the face direction of the person 500 is also merely referred to as a direction of the person 500.

Since a process of detecting the person 500 from the camera information and a process of detecting the position and direction of the person's face are known techniques, the descriptions thereof are omitted.

A decision unit 69 decides a projection mode of light for displaying the display data based on the visibility of the display information 75. The decision unit 69 includes a display data correction unit 60 that outputs corrected data obtained by correcting the display data. The corrected data is an example of information indicating the projection mode of light. Further, correcting the display data to generate the corrected data is an example of deciding the projection mode of light.

The display data correction unit 60 will be described below as a specific example of the decision unit 69. An operation of the decision unit 69 described below can also be regarded as an operation of the display data correction unit 60, and the operation of the display data correction unit 60 can also be regarded as the operation of the decision unit 69.

The display data correction unit 60 includes a visibility determination unit 61, a correction data storage unit 62, and a correction processing unit 63.

The display data correction unit 60 performs a process of determining the visibility of the display information 75 by the display data 55 as viewed from the position of the person 500 in the vicinity of the vehicle, and when the display information 75 is being visible, the display data correction unit 60 identifies the irradiation method suitable for visually recognizing the display information 75. The display data correction unit 60 corrects the display data 55 and outputs corrected data 65. Here, the display information 75 refers to a display pattern projected onto a projection surface 600 based on the display data 55. The display information 75 is mainly constituted of a figure, and may include a symbol, a character, sound, and voice.

The visibility determination unit 61 estimates based on the road surface state and the weather state which are obtained by the environment state detection unit 30, a distributed-light distribution of the display information 75 output from an information display unit 70 in a current environment state. Here, the distributed-light distribution is an output direction of light irradiated from the vehicle and light reflected from the road surface, and is intensity of the light in each direction.

The visibility determination unit 61 determines the visibility of the display information 75 as viewed from the position of the person 500 in the vicinity of the vehicle who visually recognizes the display information 75, based on the distributed-light distribution information of the display information 75, and the face position and direction of the person 500 who visually recognizes the display information 75 which are obtained by the person detection unit 40. Here, the visibility is a collapse degree or a dazzling degree of the figure of the display information 75 as viewed from the position of the person 500.

The visibility determination unit 61 decides based on the visibility determination result, the display position and angle at which the display information 75 is to be irradiated. A positional relationship between the person 500 who visually recognizes the display information 75 and the display information 75 is obtained based on the decided display position and angle of the display information 75.

The correction data storage unit 62 stores correction data 64 for correcting the display data 55 according to the environment state and the position of the person 500. The correction data 64 stored in the correction data storage unit 62 is data regarding the intensity of the light, for example, according to the road surface state such as being dry, wet, or frozen, and the position of the person 500 who visually recognizes the display information 75 as viewed from the position of the front, the side, the back, or the like of the display information 75.

The correction processing unit 63 decides the luminance degree or the hue when the display information 75 is irradiated, based on the road surface state obtained by the visibility determination unit 61, the weather state, the positional relationship between the person 500 and the display information 75, and the correction data 64 stored in the correction data storage unit 62. Further, a horizontal direction angle and a vertical direction angle are obtained as an irradiation direction of the display information 75 based on the display position and angle of the display information 75 obtained by the visibility determination unit 61.

The information display unit 70 displays the display information onto the projection surface based on the projection mode of light decided by the decision unit 69. Specifically, the information display unit 70 irradiates the display information 75 onto the projection surface 600 such as the road surface based on the corrected data 65.

The information display unit 70 performs a process of displaying information toward the outside of the vehicle according to the corrected data 65 output from the display data correction unit 60. A light irradiation unit 71 of the information display unit 70 irradiates, for example, laser light or LED (Light Emitting Diode) light onto the projection surface 600 outside the vehicle according to the corrected data 65 output from the display data correction unit 60. Thus, the light irradiation unit 71 displays onto the projection surface 600, the information indicating the vehicle state.

As the projection surface 600 for the light, a road surface around the vehicle, a wall surface around the vehicle, a building surface around the vehicle, a surface of an installed object around the vehicle, a body of the vehicle, a window of the vehicle, or the like is considered. The body or the window of the vehicle is assumed to be included in the projection surface outside the vehicle.

<Hardware Configuration of Information Display Device 100>

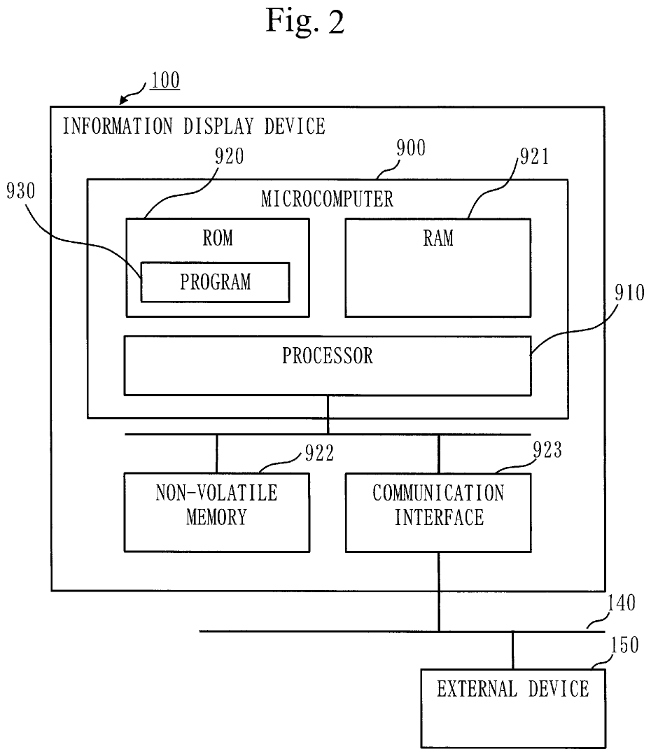

FIG. 2 is an example illustrating a hardware configuration of the information display device 100 according to the first embodiment. The information display device 100 includes as main components: a microcomputer 900 including an ROM 920, an RAM 921, and a processor 910; a non-volatile memory 922; and a communication unit that is a communication interface 923 with an on-vehicle apparatus.

The communication interface 923 communicates with an external device 150 such as the on-vehicle apparatus via the in-vehicle network 140.

Here, the information display device may be a configuration in which one device realizes all of the vehicle information acquisition unit 10, the vehicle state identifying unit 20, the display data acquisition unit 50, the display data correction unit 60, the environment state detection unit 30, the person detection unit 40, and the information display unit 70. Also, the information display device may be a configuration in which only the information display unit 70 is realized by another device. That is, a combination of each processing unit is arbitrary. Besides, in a case of realizing with a plurality of devices, data exchange is mutually performed by a communication interface provided in each of the devices.

The processor 910 is a device that executes a program 930.

The processor 910 is an IC (Integrated Circuit) that performs arithmetic processing. A specific example of the processor 910 is a CPU (Central Processing Unit), a DSP (Digital Signal Processor), or a GPU (Graphics Processing Unit).

The RAM 921 is a storage device that temporarily stores data.

A specific example of the RAM 921 is an SRAM (Static Random Access Memory) or a DRAM (Dynamic Random Access Memory).

The ROM 920 is a storage device that permanently stores data.

The ROM 920 stores the program 930.

The non-volatile memory 922 is a storage device that keeps data.

A specific example of the non-volatile memory 922 is an HDD.

Further, the non-volatile memory 922 may be a portable storage medium such as a memory card, an NAND flash, a flexible disk, an optical disk, or a compact disk.

The communication interface 923 has a receiving unit for receiving data and a transmitting unit for transmitting data.

The communication interface 923 has, for example, a communication chip, an NIC (Network Interface Card), or the like.

The program 930 is an information display program that realizes functions of the vehicle information acquisition unit 10, the vehicle state identifying unit 20, the display data acquisition unit 50, the display data correction unit 60, the environment state detection unit 30, the person detection unit 40, and the information display unit 70.

The information display program is read from the ROM 920 into the processor 910 and is executed by the processor 910.

In addition to the information display program, the ROM 920 also stores an OS (Operating System).

The processor 910 executes the information display program while executing the OS.

The information display program and the OS may be stored in the non-volatile memory 922.

The information display program and the OS stored in the non-volatile memory 922 are loaded into the RAM 921 and is executed by the processor 910.

Besides, a part or all of the information display program may be incorporated in the OS.

The information display device 100 may include a plurality of processors that replace the processor 910. This plurality of processors share the execution of the information display program. Each of the processors is a device that executes the information display program in a same manner as the processor 910.

Data, information, a signal value and a variable value used, processed, or output by the information display program are stored in the RAM 921, the non-volatile memory 922, or a register or a cache memory in the processor 910.

“unit” of each unit of the vehicle information acquisition unit 10, the vehicle state identifying unit 20, the display data acquisition unit 50, the display data correction unit 60, the environment state detection unit 30, the person detection unit 40, and the information display unit 70 may be replaced with “process”, “procedure”, or “step”. Further, the “process” of each process of the vehicle information acquisition unit 10, the vehicle state identifying unit 20, the display data acquisition unit 50, the display data correction unit 60, the environment state detection unit 30, the person detection unit 40, and the information display unit 70 may be replaced with “program”, “program product”, or “computer-readable storage medium recording a program”.

The information display program causes a computer to execute each process, each procedure, or each process obtained by replacing the “unit” of each unit described above with “process”, “procedure”, or “step”. Further, the information display method is a method performed by the information display device 100 executing the information display program.

The information display program may be provided by being stored in a computer-readable recording medium. Further, the information display program may be provided as a program product.

Further, the information display device 100 may be realized by a processing circuit such as a logic IC (Integrated Circuit), a GA (Gate Array), an ASIC (Application Specific Integrated Circuit), or an FPGA (Field-Programmable Gate Array).

Further, a superordinate concept of a processor, a memory, a combination of the processor and the memory, and a processing circuit is called a “processing circuitry”. That is, each of the processor, the memory, the combination of the processor and the memory, and the processing circuit is a specific example of the “processing circuitry”.

***Description of Operation***

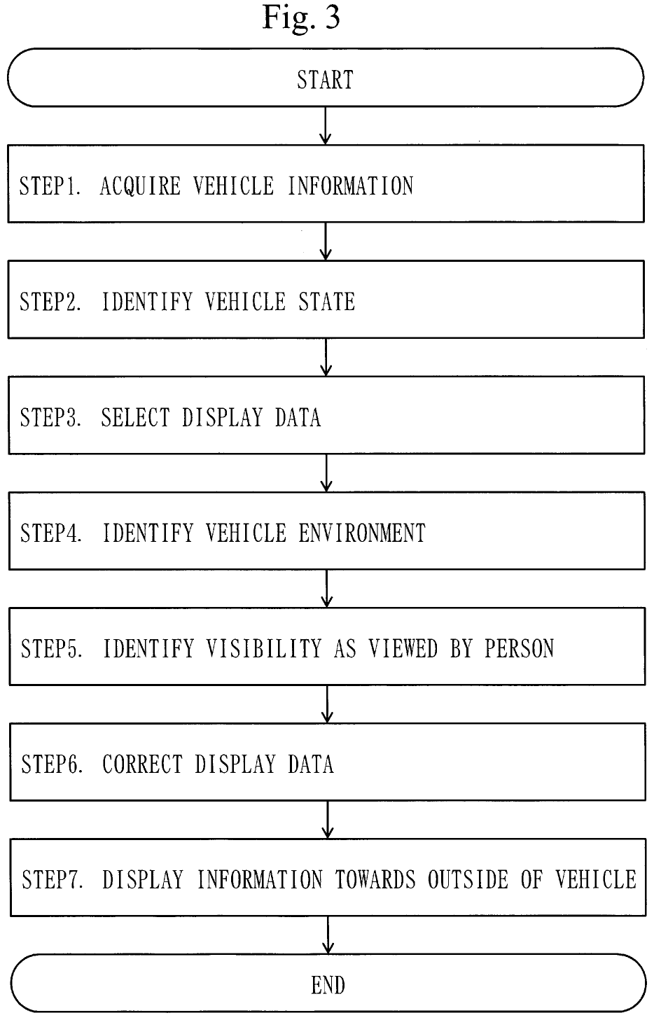

FIG. 3 is a flowchart illustrating an information display method which is a processing procedure of the information display device 100 according to the first embodiment. The information display device 100 executes a following flow.

<Step 1: Vehicle Information Acquisition Step by Vehicle Information Acquisition Unit 10>

The vehicle information acquisition unit 10 acquires the vehicle information 15 indicating the vehicle state via the in-vehicle network 140 from the on-vehicle apparatus, and outputs the vehicle information 15 to the vehicle state identifying unit 20.

<Step 2: Vehicle State Determination Step by Vehicle State Identifying Unit 20>

The vehicle state identifying unit 20 receives the vehicle information 15 from the vehicle information acquisition unit 10, identifies the vehicle state based on the vehicle information 15, and outputs the state information 25. The state information 25 includes: for example, information indicating behavior of the vehicle such as a backward movement or a forward movement; vehicle state information such as a vehicle speed; and obstacle information on the vicinity of the vehicle. For example, a start of the backward movement can be determined based on operation information of a shift lever notified with the vehicle information 15.

<Step 3: Display Data Acquisition Step by Display Data Acquisition Unit 50>

The display data selection unit 52 of the display data acquisition unit 50 selects the display data 55 corresponding to the vehicle state identified by the vehicle state identifying unit 20 from the plurality of pieces of display data stored in the display data storage unit 51. The data stored in the display data storage unit 51 is information presented to the outside of the vehicle for each state of the vehicle, and is the display data 55 which is an animation including the information presented to the outside of the vehicle. The animation data is data which is a moving image pattern conveying a figure such as an arrow, or a traveling direction of the vehicle.

For example, if the vehicle state identified by the vehicle state identifying unit 20 is the backward movement, the display data selection unit 52 selects the arrow figure to be displayed behind the vehicle as the display data 55.

Further, if the vehicle state identified by the vehicle state identifying unit 20 is the backward movement and a pedestrian is detected as an obstacle in the vicinity of the vehicle, the display data selection unit 52 selects the display data 55 with a red color or the display data 55 including a blinking pattern, which conveys a movement of the vehicle more easily.

The display data acquisition unit 50 outputs the display data 55 selected by the display data selection unit 52.

<Step 4: Detection Step by Environment State Detection Unit 30 and Person Detection Unit 40>

Based on the vehicle information 15 acquired by the vehicle information acquisition unit 10, the environment state detection unit 30 identifies as the environment state outside the vehicle, the state of the projection surface onto which the display information 75 is projected, or a weather state when the display information 75 is projected. Then, the environment state detection unit 30 outputs the environment state as the environment information 35.

The environment state detection unit 30 identifies an unevenness state of the road surface, a presence/absence state of a puddle, and the road surface state such as being dry, wet, submerged, snow-covered, or frozen, as the state of the projection surface based on the video information of the vehicle front camera or the vehicle rear camera in the vehicle information 15 acquired by the vehicle information acquisition unit 10.

The environment state detection unit 30 detects as the weather state: information regarding a weather in the vicinity of the vehicle such as rain, snow, or fog; and a degree of the weather such as rainfall or fog density, based on weather information regarding the rainfall acquired by a rain sensor, weather information on the vicinity of the vehicle acquired by a car navigation device, and the like in the vehicle information 15 acquired by the vehicle information acquisition unit 10.

The person detection unit 40 detects the person 500 in the vicinity of the vehicle from the video information of the vehicle front camera or the vehicle rear camera in the vehicle information 15 acquired by the vehicle information acquisition unit 10, and outputs the person 500 as the person detection information 45. The person detection unit 40 detects the face position and direction of a pedestrian, or a passenger of a bicycle or an automobile from the video information of the camera.

<Step 5: Determination Step by Display Data Correction Unit 60>

The visibility determination unit 61 of the display data correction unit 60 estimates the distributed-light distribution of the display information 75 in a current irradiation state which is output by the information display unit 70, based on the road surface state and the weather state acquired by the environment state detection unit 30.

Subsequently, the visibility determination unit 61 determines the visibility of the display information 75 as viewed from the position of the person 500 in the vicinity of the vehicle who visually recognizes the display information 75, based on the distributed-light distribution information of the display information 75 and the face position and direction of the person 500 who visually recognizes the display information 75 which are obtained by the person detection unit 40.

The visibility determination unit 61 decides based on the visibility determination result, a position and an angle at which the display information 75 is irradiated.

The visibility determination unit 61 obtains the positional relationship between the person 500 who visually recognizes the display information 75 and the display information 75 based on the decided display position and angle of the display information 75.

<Step 6: Correction Step by Display Data Correction Unit 60>

The correction processing unit 63 of the display data correction unit 60 decides the luminance degree or the hue when the display information 75 is irradiated, based on the road surface state, the weather state, the positional relationship between the person 500 and the display information 75 which are obtained by the visibility determination unit 61, and the correction data 64 stored in the correction data storage unit 62.

Further, the correction processing unit 63 obtains the horizontal direction angle and the vertical direction angle as the irradiation direction of the display information 75 based on the display position and the angle of the display information 75 obtained by the visibility determination unit 61.

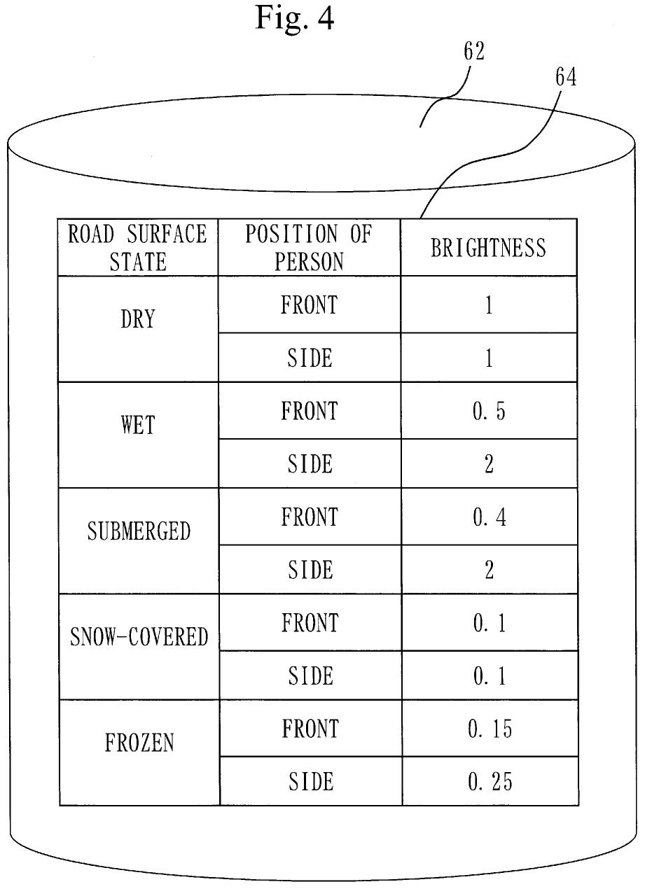

FIG. 4 illustrates a specific example of the correction data 64 when the face direction is the front facing.

Although not illustrated, the correction data storage unit 62 also stores the correction data when the face direction is the side facing or the back facing.

In FIG. 4, the road surface state and the position of the person are combined, and the brightness of the light when the display information 75 is output is stored for each combination. For example, when the road surface state is a wet state and the position of the person is on the side, the correction processing unit 63 makes a correction to double the brightness.

A specific example regarding the process of the display data correction unit 60 will be described later.

<Step 7: Information Display Step by Information Display Unit 70>

The information display unit 70 irradiates the display information 75 onto the road surface based on the corrected data 65.

The light irradiation unit 71 of the information display unit 70 irradiates laser light or LED light onto the projection surface 600 outside the vehicle toward the outside of the vehicle according to the corrected data 65 output from the display data correction unit 60.

When the light is irradiated onto the road surface, the irradiation angle of the light irradiation unit 71 is adjusted based on the horizontal direction angle and the vertical direction angle obtained by the display data correction unit 60. The irradiation angle adjustment of the light irradiation unit 71 may be a mechanism that controls the position of the light irradiation unit 71 using a motor, or may be a mechanism that controls the position at which light is irradiated, by mounting a shade and changing the position of the shade.

Also, the irradiation angle adjustment of the light irradiation unit 71 may be a mechanism that prepares a plurality of light sources for the light irradiation unit 71 and lights only the light source corresponding to the irradiated position.

Besides, a specific example regarding the display process of the information display unit 70 will be described later.

<<Display Data Correction Process of Display Data Correction Unit 60 and Display Process of Information Display Unit 70>>

Hereinafter, specific examples of the display data correction process of the display data correction unit 60 and the display process of the information display unit 70 will be described.

<Correction and Display for Collapse of Display Information 75>

The visibility determination unit 61 of the display data correction unit 60 identifies the unevenness state of the road surface which is the projection surface 600 of the display information 75 based on the road surface state obtained by the environment state detection unit 30.

When a figure having both a lighting area and a lights-out area is displayed as the display data, the light is diffusely reflected on the road surface of a road whose road surface is highly uneven or a road in a snow-covered state. Then, when the display information 75 is viewed from the front, the figure of the display information 75 looks collapsing. On the other hand, when the figure is viewed from the back, the collapse of the figure is small, and the figure of the display information 75 can be visually recognized unerringly.

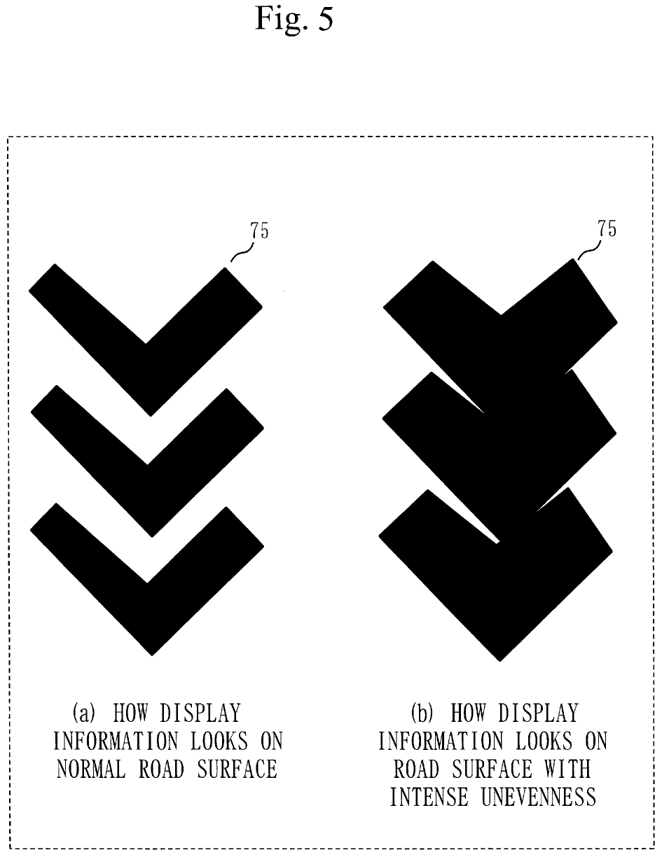

(a) of FIG. 5 illustrates how the display information 75 looks on a normal road surface. (b) of FIG. 5 illustrates how the display information 75 looks on a road surface which is highly uneven.

The visibility determination unit 61 determines the visibility of the display information 75 as viewed from the position of the person 500 in the vicinity of the vehicle who visually recognizes the display information 75, based on the position and direction of the person 500 who visually recognizes the display information 75 which are obtained by the person detection unit 40. That is, the visibility determination unit 61 determines a difference in visibility depending on the position of the person 500. For example, a degree of collapse of the figure looks large to the person 500 positioned in front of the display information 75, and a degree of collapse of figure looks small to the person 500 positioned at the back of the display information 75.

If it is determined that the degree of collapse of the figure is small as the visibility of the display information 75 by the display data 55, the correction processing unit 63 does not correct the display data 55. The correction processing unit 63 outputs the display data 55 acquired by the display data acquisition unit 50 as the corrected data 65.

<Switching Display Positions (Switching Display Positions by Changing Irradiation Angle in Horizontal Direction)>

On the other hand, if it is determined that the degree of collapse of the display information 75 is large, the correction processing unit 63 detects a place with less unevenness of the road surface, on the road surface onto which the display information 75 is irradiated. Then, the correction processing unit 63 generates the corrected data 65 obtained by changing in the horizontal direction, the irradiation angle at the time of irradiating the display information 75 so as to irradiate onto the place with less unevenness of the road surface.

As a method for the correction processing unit 63 to detect the place with less unevenness of the road surface, the correction processing unit 63 can identify the place by irradiating grid-like light onto the road surface, shooting the irradiated grid-like light with a camera, and checking the degree of collapse of the grid-like light based on the image taken with the camera. Alternatively, a known method for estimating the road surface state based on the image taken with a camera may be used.

The information display unit 70 outputs the display information 75 onto the projection surface 600 according to the corrected data 65 corrected by the display data correction unit 60. A method for changing the light irradiation angle can be realized by attaching a motor to the light irradiation unit 71 and changing the angle of the light irradiation unit 71 by controlling the motor. In addition, the method can be realized by selecting a light source to light as the light irradiation unit 71 configured by a plurality of light sources, or by changing the position at which the light is irradiated, by providing a shade in the light irradiation unit 71 and controlling the shade.

<Switching Display Positions (Switching Display Positions by Selecting Light Irradiation Unit 71)>

A case will be described in which the display information 75 is difficult to view since there is an undulation on the road surface.

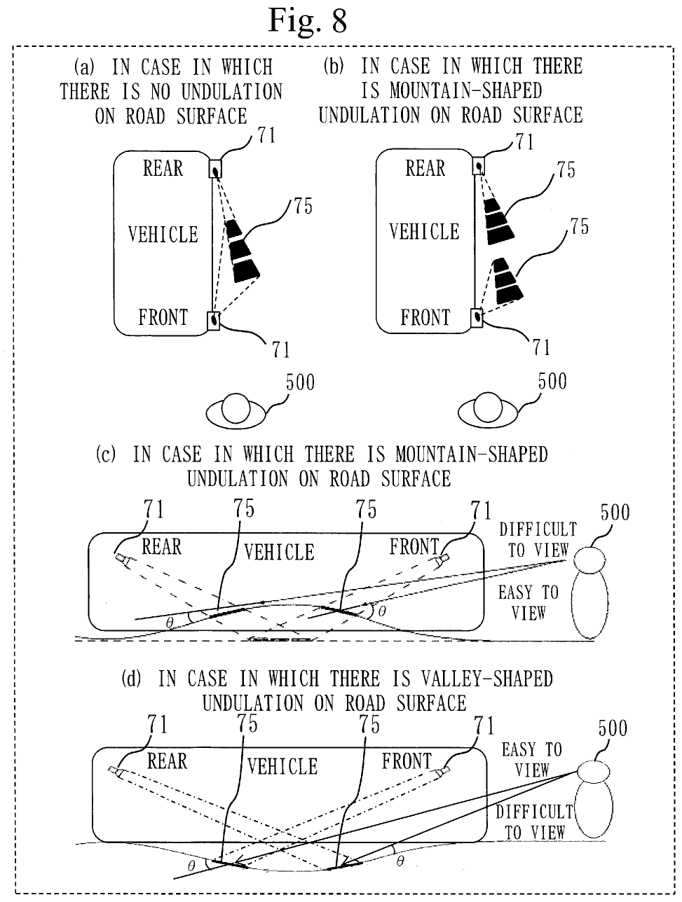

As illustrated in (a) and (b) of FIG. 8, a case will be described in which the display data is projected by physically mounting a plurality of light irradiation units 71 in the front and rear of the vehicle in the traveling direction and by selecting one of the light irradiation units 71 based on the road surface state of whether or not there is an undulation on the road surface.

As illustrated in (a) of FIG. 8, it is assumed that if the road surface is flat, the plurality of light irradiation units 71 can display the same display information at the same position (position at the center between the front and the rear of the vehicle) in a front and rear direction of the vehicle.

As illustrated in (b) of FIG. 8, if there is an undulation on the road surface between the front end and the rear end of the vehicle, the display positions of the plurality of light irradiation units 71 are different.

As illustrated in (c) of FIG. 8, when there is a mountain-shaped undulation on the road surface between the front end and the rear end of the vehicle, it is difficult to visually recognize the display information 75 if the display information 75 is projected onto a slope farther from the person 500. However, it is easy to visually recognize the display information 75 if the display information 75 is projected onto a slope closer to the person 500.

As illustrated in (d) of FIG. 8, when there is a valley-shaped undulation on the road surface between the front end and the rear end of the vehicle, it is difficult to visually recognize the display information 75 if the display information 75 is projected onto a slope closer to the person 500. However, it is easy to visually recognize the display information 75 if the display information 75 is projected onto a slope farther from the person 500.

The visibility determination unit 61 of the decision unit 69 identifies an undulation state of the road surface which is the projection surface 600 of the display information 75 based on the road surface state obtained by the environment state detection unit 30, and determines whether or not the display information 75 is difficult to view.

As a method for the visibility determination unit 61 to determine whether or not the display information 75 is difficult to view, the visibility determination unit 61 determines that the display information 75 is difficult to view if there is an undulation on the road surface and the irradiation direction of the light of the light irradiation unit 71 is a direction towards the person 500 and the light is irradiated in that direction. As illustrated in (c) and (d) of FIG. 8, it is difficult to view the display information 75 if the position of the person is on the front side of the vehicle and the light irradiation direction is from the rear to the front.

In this way, the decision unit 69 identifies the visibility of the display information based on an environment state which is an undulation on the road surface and a positional relationship between the light projection direction and the position of the person.

Here, the light projection direction includes a projection direction towards the person 500 and a projection direction away from the person 500.

The projection direction towards the person 500 refers to a case in which the display information is displayed between the light irradiation unit 71 and the person 500.

The projection direction away from the person 500 refers to a case in which the display information is displayed somewhere except between the light irradiation unit 71 and the person 500.

Alternatively, as another method for determining whether or not the display information 75 is difficult to view, the visibility determination unit 61 determines an inclination angle of the road surface onto which the display information 75 is displayed, based on the road surface state obtained by the environment state detection unit 30. Then, the visibility determination unit 61 determines an inclination angle of a line of sight of the person 500 based on the position of the person 500 and the position at which the display information 75 is displayed. Finally, if an intersection angle θ formed by the inclination angle of the road surface and the inclination angle of the line of the sight of the person 500 is less than or equal to a predetermined threshold, the visibility determination unit 61 may determine that the display information 75 is difficult to view.

If the visibility determination unit 61 determines that there is an undulation on the road surface and the display information 75 is difficult to view, the decision unit 69 determines whether to switch the light irradiation units 71.

As a method for the decision unit 69 to determine whether to switch the light irradiation units 71, the decision unit 69 determines the inclination angle of the road surface based on the road surface state obtained by the environment state detection unit 30. Then, the decision unit 69 determines the inclination angle of the line of the sight of the person 500 based on the position of the person 500 and the position at which the display information 75 is displayed. Further, the decision unit 69 determines a magnitude of the intersection angle θ formed by the inclination angle of the road surface and the inclination angle of the line of the sight of the person 500. Finally, the decision unit 69 selects the light irradiation unit 71 having a larger intersection angle θ.

In (c) of FIG. 8, the decision unit 69 selects the light irradiation unit 71 on the front side having the larger intersection angle θ.

In (d) of FIG. 8, the decision unit 69 selects the light irradiation unit 71 on the front side having the larger intersection angle θ.

Although not illustrated, in (c) of FIG. 8, if the person 500 is on the rear side instead of the front side, the decision unit 69 selects the light irradiation unit 71 on the rear side having the larger intersection angle θ.

In (d) of FIG. 8, if the person 500 is on the rear side instead of the front side, the decision unit 69 selects the light irradiation unit 71 on the rear side having the larger intersection angle θ.

A relationship between the undulation state of the road surface, the position of the person, and the light irradiation direction is as follows.

Undulation=mountain-shape, position of person=front side of vehicle, light irradiation direction=front to rear ((c) of FIG. 8)

Undulation=valley-shape, position of person=front side of vehicle, light irradiation direction=front to rear ((d) of FIG. 8)

Undulation=mountain-shape, position of person=rear side of vehicle, light irradiation direction=rear to front (not illustrated)

Undulation=valley-shape, position of person=rear side of vehicle, light irradiation direction=rear to front (not illustrated)

Thus, no matter whether an undulation is the mountain-shape or the valley-shape, if the position of the person is on the front side of the vehicle, the light irradiation unit 71 mounted on the front part of the vehicle is selected to set the light irradiation direction to be the front to the rear. In addition, if the position of the person is on the rear side of the vehicle, the light irradiation unit 71 mounted on the rear part of the vehicle is selected to set the light irradiation direction to be the rear to the front. In other words, it is sufficient if the decision unit 69 selects the light irradiation unit 71 that irradiates the light in the irradiation direction away from the person 500.

As described above, the decision unit 69 selects the light irradiation unit 71 in consideration of following two points.
A. Environment state (road surface state of whether or not there is an undulation on the road surface)
B. Relationship between the light irradiation direction and the position of the person (irradiation direction away from the person 500) The correction processing unit 63 of the decision unit 69 generates data for switching the light irradiation units 71.

The information display unit 70 switches the light irradiation units 71 based on the data for switching the light irradiation units 71, and outputs the display information 75 onto the projection surface 600.

As described above, the decision unit 69 identifies the visibility of the display information to be projected, based on the environmental state, the position of the person, and the light projection direction, and decides the projection mode of light in which the display information is displayed, based on the visibility. The decision unit 69 decides the light projection direction, and includes in the information indicating the projection mode of light, the data for instructing a switch of the light irradiation units 71.

Note that, the light irradiation units 71 may be three or more.

Further, a case in which there is an undulation on the road surface is not limited to a mountain-shape or a valley-shape, and may be an uneven road surface caused by being snow-covered, a road surface which is highly uneven, or a sloped surface such as a slant.

<Switching Contrasts>

If a place with less unevenness of the road surface cannot be found, specifications of the display data 55 are changed. As a method for changing the specifications of the display data 55, there are a method for increasing a spatial contrast and a method for increasing a temporal contrast. If a figure or the like is used as the display data 55, the correction processing unit 63 increases the spatial contrast by correcting the display data 55 so as to widen an distance between the lighting area and the lights-out area of the display data 55.

(a) of FIG. 6 illustrates a display pattern on a normal road surface. (b) of FIG. 6 illustrates the display information 75 by the corrected data corrected so as to widen the distance between the lighting area and the lights-out area of the display information 75 on a road surface which is highly uneven.

When an animation such as blinking is provided as the display data 55, the correction processing unit 63 raises the temporal contrast by correcting the display data 55 so as to increase a lighting time.

The information display unit 70 outputs the display information 75 onto the projection surface 600 according to the corrected data 65 corrected by the display data correction unit 60. As a method for changing the distance between the lighting area and the lights-out area of the display data 55, it is possible to change the display data 55 by providing a shade on the light irradiation unit 71 and controlling the shade. As a method for controlling the shade, it is possible to change the distance between the lighting area and the lights-out area by a desired distance by preparing two shades and shifting overlapping positions of the shades.

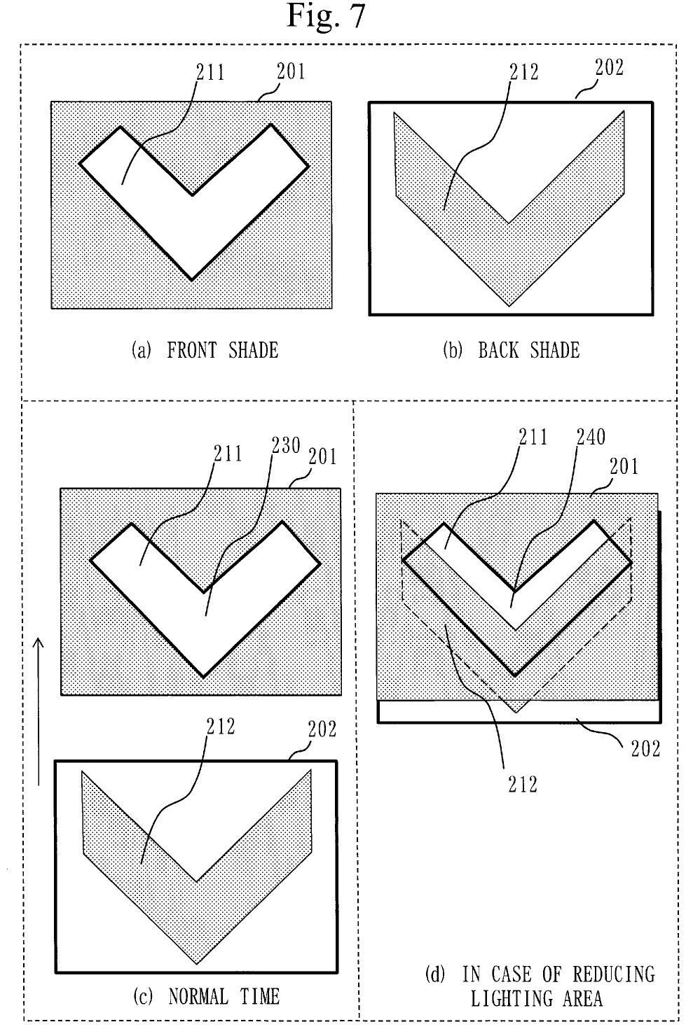

(a) of FIG. 7 illustrates a front shade 201 having a light transmitting portion 211 in a V-shape. (b) of FIG. 7 illustrates a back shade 202 having a light shielding portion 212 in a V-shape.

(c) of FIG. 7 illustrates a normal display method in which the back shade 202 is not overlapped on the front shade 201. In a case of (c) of FIG. 7, the light is irradiated from the light transmitting portion 211 in the V-shape of the front shade 201. In a case of (c) of FIG. 7, a lighting area 230 is formed by an entire light transmitting portion 211 in the V-shape of the front shade 201.

(d) of FIG. 7 illustrates a display method in which the back shade 202 is slid in the direction of the arrow with respect to the front shade 201 to reduce the lighting area of the front shade 201. In a case of (d) of FIG. 7, an approximately half of the light transmitting portion 211 in the V-shape of the front shade 201 is covered by the light shielding portion 212 in the V-shape of the back shade 202. In the case of (d) of FIG. 7, a lighting area 240 that is half of the light transmitting portion 211 in the V-shape of the front shade 201 is formed.

<<Correction and Display for Increase in Brightness of Display Information 75>>

The visibility determination unit 61 of the display data correction unit 60 identifies the distributed-light distribution of the display information 75 in a current irradiation state based on the display data 55 acquired by the display data acquisition unit 50 and the road surface state and the weather state which are obtained by the environment state detection unit 30.

As for a light reflection according to the road surface state, if it is a dry state, the light is diffused on the road surface and can be viewed with a same brightness no matter from which position around the display pattern the light is checked. On the other hand, when the road surface state is being covered with a water layer such as a submerged state, the reflection light from the road surface has high specular reflection light and weak diffused light. Therefore, if the display pattern is checked directly from the front, the display pattern looks brighter. Further, if the display pattern is checked from the side or the back, the display patter looks dark.

That is, if the road surface state is a dry state, the distributed-light distribution of the display information 75 has an approximately same light intensity as viewed at any angle around the display pattern. In addition, if the road surface state is a submerged state, the distributed-light distribution of the display information 75 has a high light intensity as viewed in the direction directly from the front around the display pattern, and has a weak light intensity as viewed from the side or the back.

In addition, when the road surface state is a snow-covered state, the light is diffused on the road surface. However, since a reflectance of snow is high, the light looks brighter as checked from any position around the display pattern.

The visibility determination unit 61 determines the visibility of the display information 75 as viewed from the position of the person 500 in the vicinity of the vehicle who visually recognizes the display information 75, based on distributed-light distribution information of the display information 75 and the position and direction of the person 500 who visually recognizes the display information 75 which are obtained by the person detection unit 40.

That is, the visibility determination unit 61 determines a difference in visibility depending on the position of the person 500. For example, if the road surface state is a submerged state, the display information 75 looks dazzling to the person 500 positioned directly in front of the display information 75. Further, for example, the display information 75 is felt dark to the person 500 positioned at the side or the back of the display information 75.

<Switching Luminance Degrees>

As the visibility of the display information 75, the correction processing unit 63 corrects the display data 55 so as to reduce the luminance degree of the irradiated light when the display information 75 is felt dazzling. Also, the correction processing unit 63 corrects the display data 55 so as to increase the luminance degree of the irradiated light when the display information 75 is felt dark.

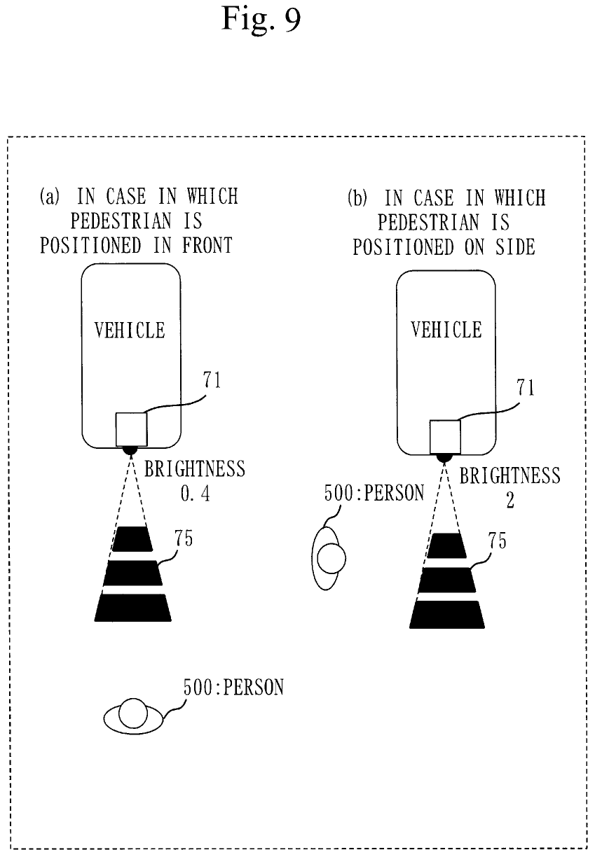

According to FIG. 9, a specific example will be described in which the visibility of the display information is identified based on the position of the person and the environment state, the projection mode of light is decided based on the visibility, and the information on the decided projection mode is output.

(a) of FIG. 9 illustrates an example in which the brightness is set to 0.4 since the pedestrian is positioned in the front.

(b) of FIG. 9 illustrates an example in which the brightness is set to 2 since the pedestrian is positioned on the side.

FIG. 9 illustrates a case in which the road surface state is the submerged state. As illustrated in FIG. 4, when the road surface state is being submerged and the position of the person is in the front, the correction processing unit 63 corrects the brightness to be 0.4 times brighter. On the other hand, when the position of the person is on the side, the correction processing unit 63 corrects the brightness to be twice brighter.

According to the conventional technique, when the road surface state as illustrated in (b) of FIG. 9 is being submerged, the reflection light from the road surface becomes strong. Thus, the brightness is weakened no matter at which position the person is. For example, if the brightness is set to 0.5, which corresponds to a normal condition (the road surface state is being dry), and the person is on the side, the diffused light is weakened. Thus, the visibility is reduced. However, in the present embodiment, when the “road surface state” is being “submerged” and the “position of person” is on the “side”, the display information is displayed in “doubled brightness” corresponding to being “submerged” and on the “side” illustrated in FIG. 4. Thus, even if the road surface state is the submerged state and the person is on the side, the visibility of the display pattern as viewed from the person can be enhanced.

<Correction According to the Number of Persons 500 or the Attribute of the Person 500>

Here, when there exist a plurality of targeted persons 500, the correction processing unit 63 performs a visibility determination on all of the persons 500 and corrects the visibility to be equal for all of the persons 500. When the visibility is not equal for all of the persons 500, the correction processing unit 63 corrects the visibility to be high for the person 500 who is highly required to be conveyed the vehicle state. As the person 500 who is highly required to be conveyed the vehicle state, the person 500 who has a closest distance to the vehicle can be targeted. Also, a child or an elderly person can be targeted by estimating an attribute such as an age of the targeted person 500.

The information display unit 70 outputs the display information 75 onto the projection surface 600 according to the corrected data 65 corrected by the display data correction unit 60.

Further, as for the light reflection on the road surface, as described above, when the road surface is covered with a water layer such as the submerged state, the reflection light from the road surface has the high specular reflection light and the weak diffused light. Thus, if the display pattern is checked directly from the front, the display pattern looks brighter. In addition, if the display pattern is checked from the side or the back, the display pattern looks dark. At this time, the intensity of the reflection light from the road surface differs depending on the angle at which the reflection light is output from the road surface. Therefore, how the light looks differs depending on a height of the targeted person 500 who visually recognizes the display pattern. In particular, the closer the incidence angle as input to the road surface and the output angle as the reflection light is output from the road surface get, the more intense the reflection light becomes.

The visibility determination unit 61 determines the visibility of the display information 75 as viewed from the position of the person 500 in the vicinity of the vehicle who visually recognizes the display information 75, based on the distributed-light distribution information of the display information 75 and the face position and direction of the person 500 who visually recognizes the display information 75 which are obtained by the person detection unit 40.

<Switching Irradiation Angles>

As the visibility of the display information 75 by the display data 55, if the display information 75 is felt dazzling, the correction processing unit 63 changes in the vertical direction, the irradiation angle at which the light is irradiated, so as to increase the incident angle as the light is input to the road surface and the angle with respect to the face position of the person 500.

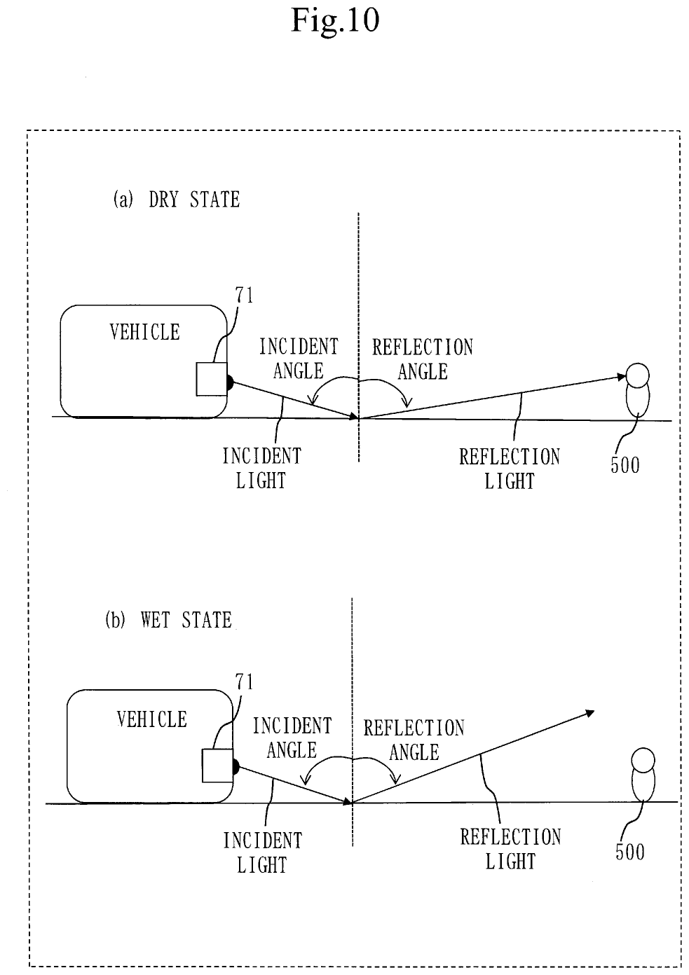

(a) of FIG. 10 illustrates an example in which the incident angle is set to a normal incident angle because of the dry state. (b) of FIG. 10 illustrates an example in which the reflection light is set to be not given to the face position of the person 500 by reducing the incident angle because of the wet state.

The information display unit 70 outputs the display information 75 onto the projection surface 600 according to the corrected data 65 corrected by the display data correction unit 60. A method for changing the light irradiation angle can be realized by attaching a motor to the light irradiation unit 71 and changing the angle of the light irradiation unit 71 by controlling the motor. Alternatively, the method can be realized by having the light irradiation unit 71 configured by a plurality of light sources, and selecting a light source to light. Also, the method can be realized by providing a shade on the light irradiation unit 71 and changing the angle by controlling the shade.

Also, it is known that when the road surface state is a dry state, a color with a high color temperature, that is, white light is preferred. Also, it is known that when the road surface state is a wet state or a submerged state, a color with a low color temperature, that is, an illumination color (yellow) is preferred. Also, it is known that even when the weather state is fog, the color with the low color temperature, that is, the illumination color (yellow) is preferred.

<Switching Hues>

The correction processing unit 63 of the display data correction unit 60 changes the hue of the display information 75 based on the weather state obtained by the environment state detection unit 30. The correction processing unit 63 changes the color to the color with the high color temperature when the road surface state is a dry state. Also, the correction processing unit 63 corrects the hue of the display information 75 to the color with the low color temperature when the road surface state is a wet state or a submerged state.

The information display unit 70 outputs the display information 75 onto the projection surface 600 according to the display data corrected by the display data correction unit 60. A method for changing the hue of the light can be realized by configuring the light irradiation unit 71 with white and yellow LEDs and blinking the white and yellow LEDs at high speed. When the light in a color close to white is output, both LEDs are blinked so as to lengthen the lighting time of the white LED and shorten the lighting time of the yellow LED.

Another method may be a configuration in which the light irradiation unit 71 is provided with a prism 301 and a light shielding plate 303 having a slit 302 in front of the prism 301. It is known that when the white light passes through the prism 301, the direction of the light exiting the prism 301 changes depending on the wavelength (dispersion). A configuration can be adopted in which only a part of the light dispersed by the prism 301 passes through the slit 302 by irradiating the light through the prism 301. Thus, it is possible to output only light with a desired color by rotating the prism 301.

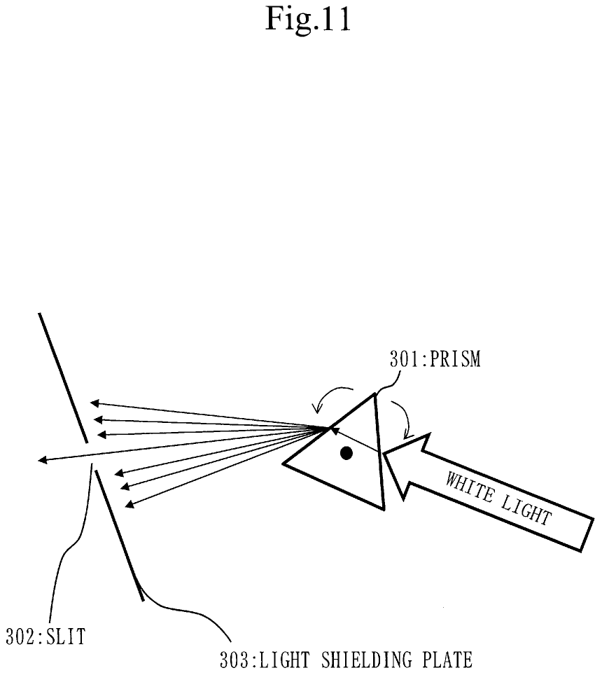

FIG. 11 illustrates an example in which the prism 301 is rotated behind the light shielding plate 303 and only a part of the light dispersed by the prism 301 passes through the slit 302.

Here, a configuration can be adopted in which as the dispersing element that disperses the light, a diffraction grating or the like is used instead of the prism 301.

If the light irradiation unit 71 of the information display unit 70 uses laser light, there is a risk of harming the person 500 in the vicinity of the vehicle. Therefore, the LED light is used instead of the laser light in a case in which the road surface state detected by the environment state detection unit 30 is a road surface state which is highly uneven, or a road surface state such as a submerged state or a frozen state. Further, the LED light is used instead of the laser light when there are a plurality of persons 500 detected by the person detection unit 40 and the display information 75 cannot be output in the direction in which the person 500 is absent.

That is, when the display data correction unit 60 detects the road surface state which is highly uneven, or the road surface state such as a submerged state or a frozen state as the road surface state detected by the environment state detection unit 30, the display data correction unit 60 corrects from the laser light to the LED light, the display data output to the information display unit 70.

Also, when there are the plurality of persons 500 detected by the person detection unit 40 and the display information 75 cannot be output in the direction in which the person 500 is absence, the display data correction unit 60 corrects from the laser light to the LED light, the display data output to the information display unit 70.

The information display unit 70 outputs the display information 75 onto the projection surface 600 according to the corrected data 65 corrected by the display data correction unit 60. When the corrected data 65 indicates that the display information 75 is output by the laser light, the information display unit 70 projects the display information 75 onto the projection surface 600 by using the laser light. When the corrected data 65 indicates that the display information 75 is output by the LED light, the information display unit 70 projects the display information 75 onto the projection surface 600 by using the LED light.

<Characteristics of Information Display Device 100>

The characteristics of the information display device 100 according to the first embodiment will be described below.

The information display device 100 according to the first embodiment is characterized by including:

the person detection unit 40 that detects the position of the person;

the environment state detection unit 30 that detects the environment state outside the vehicle;

the decision unit 69 that identifies the visibility of the display information projected onto the projection surface 600 based on the position of the person detected by the person detection unit 40 and the environment state detected by the environment state detection unit 30, and decides the projection mode of light for displaying the display information based on the visibility; and the information display unit 70 that projects the light onto the projection surface 600 based on the projection mode decided by the decision unit 69.

The decision unit 69 further identifies the visibility of the display information based on the light projection direction, and decides the light projection direction based on the visibility.

The information display device 100 according to the first embodiment includes: the vehicle information acquisition unit 10 that acquires the vehicle information 15 from the in-vehicle network 140; the vehicle state identifying unit 20 that identifies the vehicle state based on the vehicle information 15 acquired by the vehicle information acquisition unit 10; and the environment state detection unit 30 that detects as the environment state, the projection surface state outside the vehicle and the weather state outside the vehicle.

The information display device 100 also includes the person detection unit 40 that detects the position and direction of the person 500.

The information display device 100 also includes the display data acquisition unit 50 that acquires the display data 55 for displaying the information based on the vehicle state identified by the vehicle state identifying unit 20.

The information display device 100 also includes the display data correction unit 60 that identifies the visibility of the display information 75 displayed by the display data 55 acquired by the display data acquisition unit 50 based on the position and direction of the person 500 which are detected by the person detection unit 40, corrects the display data 55 based on the visibility, and outputs the corrected data 65.

Further, the information display device 100 includes the information display unit 70 that displays the information based on the corrected data 65 output by the display data correction unit 60.

The display data correction unit 60 corrects the display data 55 based on the projection surface state detected by the environment state detection unit 30, the weather state outside the vehicle, and the information on the position and direction of the person 500 which are detected by the person detection unit 40.

The information display unit 70 displays the vehicle state onto the projection surface 600 by irradiating the light onto the projection surface 600 outside the vehicle based on the corrected data 65.

The display data correction unit 60 identifies the visibility of the display information 75 as viewed from the person 500 based on the position of the person 500 and the face direction.

The display data correction unit 60 generates at least one of following pieces of corrected data 65 (projection mode of light) according to the visibility of the display information 75.

1. Corrected data 65 for switching the display positions of the display information 75 (projection mode of light),

2. Corrected data 65 for switching the spatial contrasts of the display information 75 (projection mode of light),

3. Corrected data 65 for switching the temporal contrasts of the display information 75 (projection mode of light),

4. Corrected data 65 for switching the luminance degrees of the display information 75 (projection mode of light),

5. Corrected data 65 for switching the irradiation angles of the display information 75 (projection mode of light),

6. Corrected data 65 for switching the hues of the display information 75 (projection mode of light), and

7. Corrected data 65 obtained by combining 1 to 7 described above (projection mode of light).

The display data correction unit 60 causes the information display unit 70 to irradiate grid-like light onto the projection surface 600, shoots the irradiated grid-like light with a camera, and detects the unevenness state of the projection surface 600 based on the collapse degree of the grid-like light from the image shot with the camera.

The information display unit 70 has a plurality of shades, and has the light irradiation unit 71 that displays the display information 75 based on the corrected data 65 by shifting the overlapping positions of the plurality of shades.

The information display unit 70 has the light irradiation unit 71 having a dispersing element that changes the hue of the display information 75.

The information display unit 70 has a plurality of types of light sources, and switches the light sources to display the display information 75.

The display data correction unit 60 corrects the display data 55 based on the number of persons or the attributes of the persons.

In the information display method of the first embodiment, the person detection unit 40 detects the position and direction of the person 500, and the display data selection unit 52 selects the display data 55 for displaying the information.

Then, the display data correction unit 60 identifies the visibility of the display information 75 displayed by the display data 55 selected by the display data selection unit 52, based on the position and direction of the person 500 detected by the person detection unit 40, corrects the display data 55 based on the visibility, and outputs the corrected data 65.

Further, the information display unit 70 displays the information onto the road surface based on the corrected data 65 output by the display data correction unit 60.

### Effect of First Embodiment

According to the information display device 100 and the information display method of the first embodiment, it is possible to detect the position of the person 500 outside the vehicle and to project the light pattern with high visibility (the intention is easily conveyed) for the targeted person 500 since the projection mode of light is decided in consideration of the visibility of the person 500 at this position.

Further, according to the information display device 100 and the information display method of the first embodiment, the projection mode of light is decided in consideration of the visibility of the targeted person according to a combination of the environment such as the weather and the road surface environment and the position of the person 500. Thus, it is possible to project a light pattern with high visibility which is suitable for the combination of the environment and the position of the person 500. In other words, as described above, the visibility of the light for the targeted person changes depending on the environment and the position of the person. Thus, it is possible to improve the visibility of the light pattern as viewed from each person's position under a specific environment by projecting the light pattern according to these combinations.

Further, according to the information display device 100 and the information display method of the first embodiment, it is possible to project a display onto the road surface which is easy for the person 500 to view in various situations by correcting the display data according to the environment or the weather, and the positional relationship between the display information 75 and the person 500.

Further, according to the information display device 100 and the information display method of the first embodiment, the display data correction unit 60 determines the visibility of the display information 75 by the display data 55 as viewed from the position of the person 500. Then, a breakdown of the display pattern of the display information 75 can be avoided by a configuration in which a display form of the display information 75 is changed based on the determination result of the visibility. Thus, it is possible to enhance the visibility of the display information 75 as viewed from the person 500.

In addition, when a figure such as an arrow is used as a display pattern to be displayed outside the vehicle, the light is diffused on the road surface in a case of a road surface which is highly uneven or a snow surface. However, according to the information display device 100 and the information display method of the first embodiment, it is possible to prevent the shape of the displayed figure from collapsing, and a conveying degree of information does not decrease.

Also, on a road surface covered with a water layer due to rainfall or on a frozen road surface, the reflection light from the road surface is intensified. However, according to the information display device 100 and the information display method of the first embodiment, no dazzling is felt when the display pattern is checked, and the conveying degree of information does not decrease.

Also, on a road surface covered with a water layer or a frozen road surface, the reflection light from the road surface is intensified, the diffused light weakens, and the intensity of the light on the side decreases. However, according to the information display device 100 and the information display method of the first embodiment, the visibility of the figure as viewed from the side does not decrease, and the conveying degree of information does not decrease.

### Modification Example of First Embodiment

Although the display data correction unit 60 that corrects the display data has been described as a specific example of the decision unit 69, the decision unit 69 is not limited to a case in which the display data selected by the display data selection unit 52 is corrected. New data, a new attribute, a new shape, and the like that do not exist in the display data may be added to the display data and decided as the projection mode of light. Alternatively, it is acceptable for the decision unit 69 not to use any existing display data, and to adopt as the projection mode of light, only the new data, the new attribute, the new shape, and the like.

That is, the projection mode decided by the decision unit 69 may be any projection mode as long as the visibility of the display data is improved according to the position of the person.

The person detection unit 40 may detect only the face position of the person 500 and output the face position as the person detection information 45. If the person detection unit 40 detects only the position of the person 500, it can be assumed that the face direction of the person 500 is always facing the front towards the display information 75.

The information display device 100 may be mounted on a two-wheeled vehicle, a three-wheeled vehicle, a ship, a walker, or other moving bodies instead of an automobile.

The person detection unit 40 may perform following detections.
1. Detection of only the position of the person 500,
2. Motion detection of the person 500 (standing, walking, running, piggybacking, holding, or being with a pet),
3. State detection of the person 500 (operating smartphone, talking on a smartphone, watching with earphones, wearing sunglasses, wearing goggles, wearing a helmet, pulling a cart, using a cane, or using a wheelchair), and
4. Attribute detection of the person 500 (adult, child, elderly person, foreigner, height) The display data correction unit 60 performs a correction according to a detection content of the person detection unit 40.

### Second Embodiment

In a second embodiment, matters different from the first embodiment will be described.

***Description of Configuration***

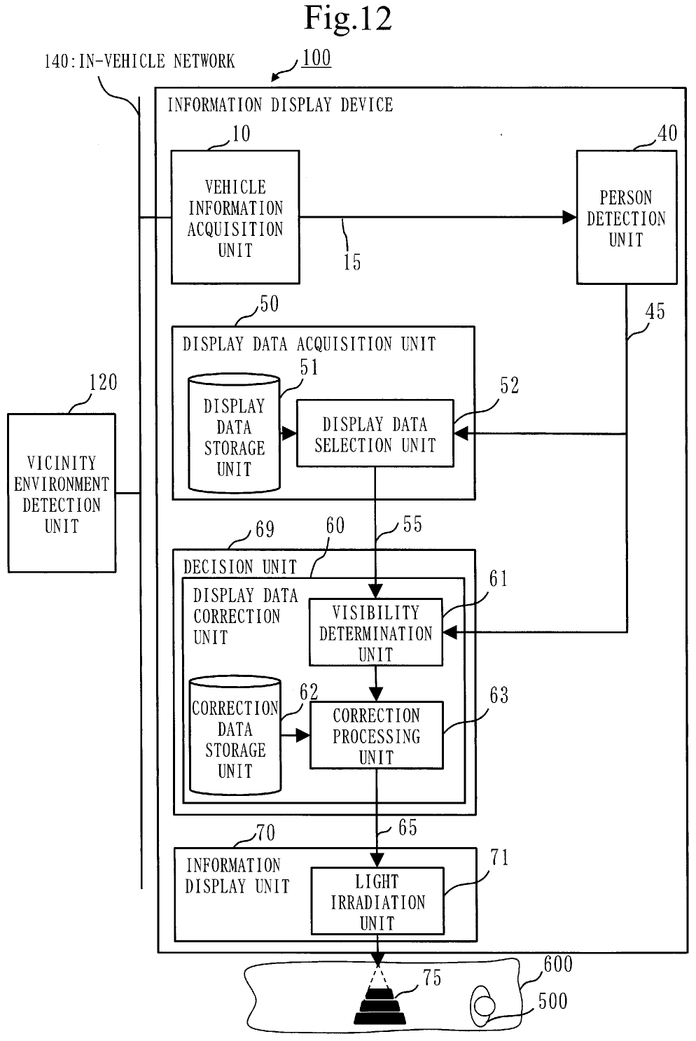

FIG. 12 is a configuration diagram of the information display device 100 according to the second embodiment.

FIG. 12 is a diagram in which the vehicle driving control unit 110, the indoor information display unit 130, the vehicle state identifying unit 20, and the environment state detection unit 30 are removed from FIG. 1 described in the first embodiment.

The information display device 100 of the second embodiment includes the person detection unit 40 that detects the position and direction of the person 500, and also includes the display data acquisition unit 50 that acquires the display data 55 that displays the information.

The information display device 100 includes the display data correction unit 60 that identifies the visibility of the display information 75 displayed by the display data 55 acquired by the display data acquisition unit 50 based on the position and direction of the person 500 detected by the person detection unit 40, corrects the display data 55 based on the visibility, and outputs the corrected data 65.

Further, the information display device 100 includes the information display unit 70 that displays the information based on the corrected data 65 output by the display data correction unit 60.

The display data correction unit 60 identifies the visibility of the display information 75 as viewed by the person 500, based on the position of the person 500 and the face direction.

***Description of Operation***

The information display device 100 of the second embodiment operates when the person detection unit 40 detects the person 500.

Operation different from the first embodiment will be described below.

<Step 5: Identifying Step by Display Data Correction Unit 60>

The visibility determination unit 61 determines the visibility of the display information 75 by the display data 55 as viewed from the position of the person 500 in the vicinity of the vehicle who visually recognizes the display information 75, based on only the face position and direction of the person 500 who visually recognizes the display information 75 obtained by the person detection unit 40.

The visibility determination unit 61 decides the position and angle at which the display information 75 is irradiated, based on a visibility determination result. The visibility determination unit 61 obtains the positional relationship between the person 500 who visually recognizes the display information 75 and the display information 75 based on the decided display position and angle of the display information 75.

<Step 6: Correction Step by Display Data Correction Unit 60>

The correction processing unit 63 of the display data correction unit 60 decides the luminance degree or the hue as the display information 75 is irradiated, based on the positional relationship between the person 500 and the display information 75 obtained by the visibility determination unit 61 and based on the correction data 64 stored in the correction data storage unit 62.

Further, the correction processing unit 63 obtains the horizontal angle and the vertical angle as the irradiation direction of the display data 55 based on the display position and the angle of the display data 55 obtained by the visibility determination unit 61. Here, the correction data 64 stored in the correction data storage unit 62 is, for example, data regarding the light intensity according to the position and the face direction of the person 500 who visually recognizes the display information 75.

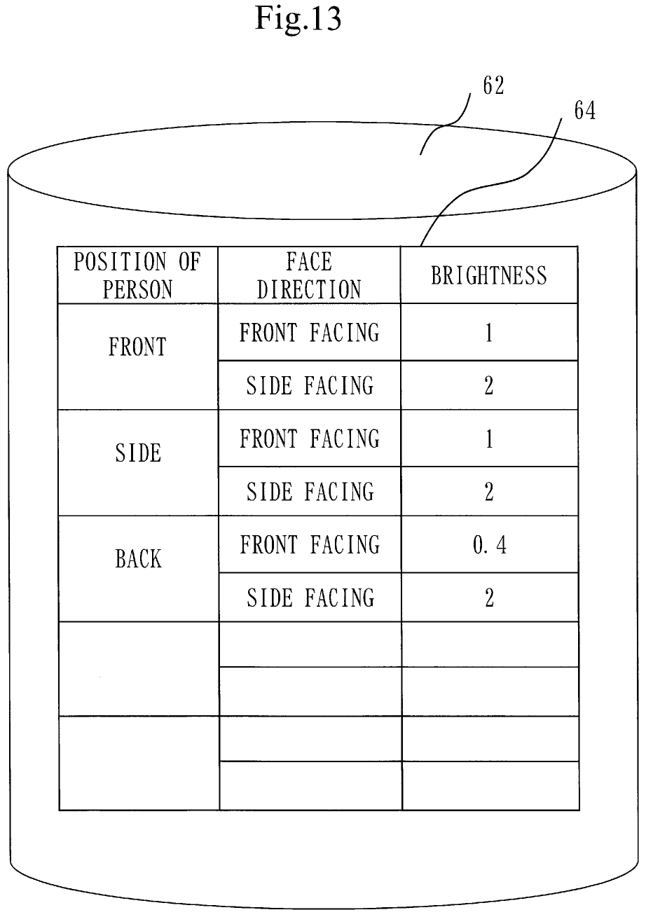

FIG. 13 illustrates a specific example of the correction data 64 stored in the correction data storage unit 62.

In FIG. 13, the position of the person and the face direction are combined, and the brightness of light as the display information 75 is output is stored for each combination. For example, when the position of the person is on the side of the display information 75 and the face of the pedestrian is on the side facing (state in which the display information 75 is obliquely viewed), the correction processing unit 63 performs a correction to double the brightness as compared with the state in which the face of the pedestrian is the front facing (the state in which the display information 75 is looked straight).

### Description of Effect of Second Embodiment

According to the second embodiment, it is possible to project onto the road surface, a display that is easy for the person 500 to view, by correcting the display data 55 according to the positional relationship of the person 500 who visually recognizes the display information 75.

Further, according to the second embodiment, it is possible to operate the information display device 100 by the person detection unit 40 only detecting the person 500. Therefore, it is possible to operate the information display device 100 even when the vehicle is not operated.

### Modification Example of Second Embodiment

The information display device 100 may be mounted on a building, a traffic light, or other installation object instead of a moving body. When the information display device 100 is mounted on the installation object, it is sufficient if the person detection unit 40 also detects the moving direction of the person 500 and the display data correction unit 60 corrects the display data 55 in consideration of the position of the person 500 and the face direction, and the moving direction.

All or part of the vehicle driving control unit 110, the indoor information display unit 130, the vehicle state identifying unit 20, and the environment state detection unit 30 described in the first embodiment may be added to the information display device 100 of the second embodiment.

### REFERENCE SIGNS LIST

10: vehicle information acquisition unit, 15: vehicle information, 20: vehicle state identifying unit, 25: state information, 30: environment state detection unit, 35: environment information, 40: person detection unit, 45: person detection information, 50: display data acquisition unit, 51: display data storage unit, 52: display data selection unit, 55: display data, 60: display data correction unit, 61: visibility determination unit, 62: correction data storage unit, 63: correction processing unit, 64: correction data, 65: corrected data, 69: decision unit, 70: information display unit, 71: light irradiation unit, 75: display information, 100: information display device, 110: vehicle driving control unit, 120: vicinity environment detection unit, 130: indoor information display unit, 140: in-vehicle network, 150: external device, 201: front shade, 202: back shade, 211: light transmitting portion, 212: light shielding portion, 230: lighting area, 240: lighting area, 301: prism, 302: slit, 303: light shielding plate, 500: person, 600: projection surface, 900: microcomputer, 910: processor, 920: ROM, 921: RAM, 922: non-volatile memory, 923: communication interface, 930: program.

1. An information display device comprising:
processing circuitry
to detect a position of a person;
to detect an environment state including a road surface state outside a vehicle;
to acquire display data for displaying information;
which has stored correction data for correcting brightness of light according to a combination of the road surface and the position of the person;
to identify based on the position of the person detected, visibility of display information as viewed from the person, displayed by the display data acquired, and decide a projection mode of light based on the visibility; and
to display the display information onto a projection surface based on the projection mode of light decided, and
wherein the processing circuitry refers to the correction data based on the combination of the road surface detected and the position of the person detected, and decides the brightness of the light based on the correction data.

2. The information display device according to claim 1,
wherein the visibility is a collapse degree or a dazzling degree of a figure of the display information as the display information displayed onto the projection surface is viewed from the position of the person,
wherein the processing circuitry
detects a direction of the person, and
identifies based on the position and the direction of the person, the visibility of the display information as viewed by the person.

3. The information display device according to claim 1,
wherein the processing circuitry decides according to the visibility of the display information, at least one projection mode of light of:
a projection mode of light to switch display positions of the display information;
a projection mode of light to switch contrasts of the display information;
a projection mode of light to switch luminance degrees of the display information;
a projection mode of light to switch irradiation angles of the display information; and
a projection mode of light to switch hues of the display information.

4. The information display device according to claim 1,
wherein the processing circuitry irradiates grid-like light onto a projection surface and detects an unevenness state of the projection surface based on a collapse degree of the grid-like light irradiated.

5. The information display device according to claim 1,
wherein the processing circuitry has a plurality of shades and displays the display information by shifting overlapping positions of the plurality of shades.

6. The information display device according to claim 1,
wherein the processing circuitry has a dispersing element to change the hue of the display information.

7. The information display device according to claim 1,
wherein the processing circuitry has a plurality of types of light sources to display the display information.

8. The information display device according to claim 1,
wherein the processing circuitry decides the projection mode of light based on the number of the persons and an attribute of the person.

9. The information display device according to claim 1 comprising:
the processing circuitry
to acquire vehicle information from an in-vehicle network; and
to identify a vehicle state based on the vehicle information acquired, and
wherein the processing circuitry
acquires the display data based on the vehicle state identified,
decides the projection mode of light based on the environment state detected and the position of the person detected, and
displays the vehicle state onto the projection surface by projecting light onto the projection surface outside the vehicle based on the projection mode of light.

10. The information display device according to claim 1,
wherein the processing circuitry
outputs as information indicating the projection mode of light, corrected data obtained by correcting the display data, and
displays the display information onto the projection surface based on the corrected data output.

11. An information display device comprising;
processing circuitry
to detect a position of a person;
to detect an environment state including a road surface state outside a vehicle;
which has stored correction data for correcting brightness of light according to a combination of the road surface and the position of the person;
to identify visibility of display information as viewed from the person, to be projected, based on the position of the person and the environment state, and decides a projection mode of light to display the display information based on the visibility; and
to project the light based on the projection mode, and
wherein the processing circuitry refers to the processing circuitry based on the combination of the road surface detected and the position of the person detected, and decides the brightness of the light based on the correction data stored.

12. The information display device according to claim 1,
wherein the processing circuitry further identify the visibility of the display information based on a projection direction of the light, and decides the projection direction of the light based on the visibility.

13. An information display method comprising:
detecting, by a person detection unit, a position and a direction of a person;
detecting, by an environment state detection unit, an environment state including a road surface state outside a vehicle;
storing, in a correction data storage unit, correction data for correcting brightness of light according to a combination of the road surface and the position of the person;
acquiring, by a display data acquisition unit, display data for displaying information;
identifying, by a decision unit, based on the position and the direction of the person detected by the person detection unit, visibility of display information as viewed from the person, displayed by the display data acquired by the display data acquisition unit, and deciding a projection mode of light based on the visibility; and
displaying, by an information display unit, the display information based on the projection mode of light decided by the decision unit, and
wherein the decision unit refers to the correction data storage unit based on the combination of the road surface detected by the environment state detection unit and the position of the person detected by the person detection unit, and decides the brightness
of the light based on the correction data stored in the correction data storage unit.
